(19) United States
(12) Patent Application Publication
(10) Pub. No.: US 2017/0339977 A1
(43) Pub. Date: Nov. 30, 2017

(54) SUBSTITUTION SYSTEMS, FROZEN DESSERT COMPOSITIONS, AND METHODS OF MANUFACTURING

(71) Applicant: PIE IN THE SKY LLC, San Clemente, CA (US)

(72) Inventors: Leif Gunnar Pearson, San Clemente, CA (US); Bruce W. Tharp, Wayne, PA (US)

(21) Appl. No.: 15/167,432

(22) Filed: May 27, 2016

(51) Int. Cl. A23G 9/34; A23G 9/32; A23G 9/40

(52) U.S. Cl. CPC A23G 9/34; A23G 9/40; A23G 9/32; A23V 2002/00

(57) ABSTRACT

A substitution system includes a high intensity sweetener and optionally a bulking agent. A frozen dessert composition includes the substitution system. The frozen dessert composition has a higher freezing point than a frozen dessert composition would have with the same sweetness but without the substitution system.

### BACKGROUND

### Field

The present disclosure relates to frozen dessert compositions and methods for making and using the same.

### Description of the Related Art

Frozen desserts are very popular among consumers. The frozen dessert market is sizeable market and continues to grow as a result of consumer demand.

### SUMMARY

Any feature, structure, or step disclosed herein can be replaced with or combined with any other feature, structure, or step disclosed herein, or omitted. Further, for purposes of summarizing the disclosure, certain aspects, advantages, and features of the inventions have been described herein. It is to be understood that not necessarily any or all such advantages are achieved in accordance with any particular embodiment of the inventions disclosed herein. No individual aspects of this disclosure are essential or indispensable.

In some embodiments, a frozen dessert composition comprises ethyl alcohol and a substitution system. The substitution system comprises a high intensity sweetener and a bulking agent.

The high intensity sweetener may be between 0.05 wt % and 1 wt %. The bulking agent may be between 5 wt % and 15 wt %. The ethyl alcohol may be between 3 wt % and 15 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The bulking agent may be selected from the group consisting of carbohydrates, corn syrup solids, proteins, and combinations thereof. The composition may further comprise milk, cream, corn syrup, and milk powder. The composition may further comprise at least one of reduced lactose milk, reduced lactose cream, reduced lactose milk powder, lactose-free milk, lactose-free cream, lactose-free milk powder, non-dairy milk, non-dairy cream, and non-dairy milk powder. The composition may further comprise a stabilizer. The composition may further comprise other flavorings. The composition may further comprise a traditional sweetener. The traditional sweetener and the high intensity sweetener may provide a sucrose sweetness equivalence. The traditional sweetener may be between 2.5 wt % to 12.5 wt %. A freezing point of the composition may be between 22.5° F. and 23.5° F. A freezing point of the composition may be within ±0.5° F. of a freezing point of an identical composition that includes traditional sweeteners and does not include a substitution system or ethyl alcohol.

In some embodiments, a frozen dessert composition comprises a substitution system. The substitution system comprises a high intensity sweetener and a bulking agent.

The high intensity sweetener may be between 0.05 wt % and 1 wt %. The bulking agent may be between 5 wt % and 15 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The bulking agent may be selected from the group consisting of carbohydrates, corn syrup solids, proteins, and combinations thereof. The composition may further comprise milk, cream, corn syrup, and milk powder. The composition may further comprise at least one of reduced lactose milk, reduced lactose cream, reduced lactose milk powder, lactose-free milk, lactose-free cream, lactose-free milk powder, non-dairy milk, non-dairy cream, and non-dairy milk powder. The composition may further comprise a stabilizer. The composition may further comprise other flavorings. The composition may further comprise a traditional sweetener. The traditional sweetener and the high intensity sweetener may provide a sucrose sweetness equivalence. The traditional sweetener may be between 2.5 wt % to 12.5 wt %. A freezing point of the composition may be between 22.5° F. and 23.5° F. A freezing point of the composition may be within ±0.5° F. of a freezing point of an identical composition that includes traditional sweeteners and does not include a substitution system. The composition may further comprise ethyl alcohol.

In some embodiments, a frozen dessert composition comprises ethyl alcohol and a substitution system. The substitution system comprises a high intensity sweetener.

The high intensity sweetener may be between 0.05 wt % and 1 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The composition may further comprise milk, cream, corn syrup, and milk powder. The composition may further comprise at least one of reduced lactose milk, reduced lactose cream, reduced lactose milk powder, lactose-free milk, lactose-free cream, lactose-free milk powder, non-dairy milk, non-dairy cream, and non-dairy milk powder. The composition may further comprise a stabilizer. The composition may further comprise other flavorings. The composition may further comprise a traditional sweetener. The traditional sweetener and the high intensity sweetener may provide a sucrose sweetness equivalence. The traditional sweetener may be between 2.5 wt % to 12.5 wt %. A freezing point of the composition may be between 22.5° F. and 23.5° F. A freezing point of the composition may be within ±0.5° F. of a freezing point of an identical composition that includes traditional sweeteners and does not include a substitution system or ethyl alcohol. The substitution system may further comprise a bulking agent.

In some embodiments, a frozen dessert composition comprises a substitution system. The substitution system comprises a high intensity sweetener.

The high intensity sweetener may be between 0.05 wt % and 1 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The composition may further comprise milk, cream, corn syrup, and milk powder. The composition may further comprise at least one of reduced lactose milk, reduced lactose cream, reduced lactose milk powder, lactose-free milk, lactose-free cream, lactose-free milk powder, non-dairy milk, non-dairy cream, and non-dairy milk powder. The composition may further comprise a stabilizer. The composition may further comprise other flavorings. The composition may further comprise a traditional sweetener. The traditional sweetener and the high intensity sweetener may provide a sucrose sweetness equivalence. The traditional sweetener may be between 2.5 wt % to 12.5 wt %. A freezing point of the composition may be between 22.5° F. and 23.5° F. A freezing point of the composition may be within ±0.5° F. of a freezing point of an identical composition that includes traditional sweeteners and does not include a substitution system or ethyl alcohol. The composition may further comprise ethyl alcohol. The substitution system may further comprise a bulking agent.

In some embodiments, a substitution system comprises a high intensity sweetener and a bulking agent.

The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The bulking agent may be selected from the group consisting of carbohydrates, corn syrup solids, proteins, and combinations thereof.

In some embodiments, a substitution system comprises a high intensity sweetener.

The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The substitution system may further comprise a bulking agent.

In some embodiments, a method of making a frozen dessert comprises mixing a liquid component, a dry component, a substitution system, and ethyl alcohol to form a frozen dessert composition. The substitution system comprises a high intensity sweetener and a bulking agent. The method further comprises freezing the frozen dessert composition into a frozen dessert.

The liquid component may comprise milk, cream, and corn syrup. The liquid component may comprise at least one of reduced lactose milk, reduced lactose cream, lactose-free milk, lactose-free cream, non-dairy milk, and non-dairy cream. The dry component may comprise milk powder and a traditional sweetener. The dry component may comprise at least one of reduced lactose milk powder, lactose-free milk powder, and non-dairy milk powder. The dry component may further comprise a stabilizer. The composition may further comprise other flavorings. The method may further comprise freezing the frozen dessert to a hardening temperature. The hardening temperature may be between −20° F. and −50° F. A freezing point of the composition may be within 0.5° F. of a freezing point of a composition not comprising the high intensity sweetener or the ethyl alcohol and having the sucrose sweetness equivalence provided solely by the traditional sweetener. The high intensity sweetener may be between 0.05 wt % and 1 wt %. The bulking agent may be between 5 wt % and 15 wt %. The ethyl alcohol may be between 3 wt % and 15 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The bulking agent may be selected from the group consisting of carbohydrates, corn syrup solids, proteins, and combinations thereof.

In some embodiments, a method of making a frozen dessert comprises mixing a liquid component, a dry component, and a substitution system to form a frozen dessert composition. The substitution system comprises a high intensity sweetener and a bulking agent. The method further comprises freezing the frozen dessert composition into a frozen dessert.

The liquid component may comprise milk, cream, and corn syrup. The liquid component may comprise at least one of reduced lactose milk, reduced lactose cream, lactose-free milk, lactose-free cream, non-dairy milk, and non-dairy cream. The dry component may comprise milk powder and a traditional sweetener. The dry component may comprise at least one of reduced lactose milk powder, lactose-free milk powder, and non-dairy milk powder. The composition may further comprise a stabilizer. The composition may further comprise other flavorings. The frozen dessert may comprise a semi-frozen frozen dessert. The method may further comprise freezing the frozen dessert to a hardening temperature. The hardening temperature may be between −20° F. and −50° F. A freezing point of the composition may be within 0.5° F. of a freezing point of a composition not comprising the high intensity sweetener or the ethyl alcohol and having the sucrose sweetness equivalence provided solely by the traditional sweetener. The composition may further comprise ethyl alcohol. The high intensity sweetener may be between 0.05 wt % and 1 wt %. The bulking agent may be between 5 wt % and 15 wt %. The ethyl alcohol may be between 3 wt % and 15 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The bulking agent may be selected from the group consisting of carbohydrates, corn syrup solids, proteins, and combinations thereof.

In some embodiments, a method of making a frozen dessert comprises mixing a liquid component, a dry component, a substitution system, and ethyl alcohol to form a frozen dessert composition. The substitution system comprises a high intensity sweetener. The method further comprises freezing the frozen dessert composition into a frozen dessert.

The liquid component may comprise milk, cream, and corn syrup. The liquid component may comprise at least one of reduced lactose milk, reduced lactose cream, lactose-free milk, lactose-free cream, non-dairy milk, and non-dairy cream. The dry component may comprise milk powder and a traditional sweetener. The dry component may comprise at least one of reduced lactose milk powder, lactose-free milk powder, and non-dairy milk powder. The dry component may further comprise a stabilizer. The composition may further comprise other flavorings. The frozen dessert may comprise a semi-frozen frozen dessert. The method may further comprise freezing the frozen dessert to a temperature. The hardening temperature may be between −20° F. and −50° F. A freezing point of the composition may be between 22.5° F. and 23.5° F. A freezing point of the composition may be within ±0.5° F. of a freezing point of an identical composition that includes traditional sweeteners and does not include a substitution system or ethyl alcohol. The substitution system may further comprise a bulking agent. The high intensity sweetener may be between 0.05 wt % and 1 wt %. The bulking agent may be between 5 wt % and 15 wt %. The ethyl alcohol may be between 3 wt % and 15 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The bulking agent may be selected from the group consisting of carbohydrates, corn syrup solids, proteins, and combinations thereof.

In some embodiments, a method of making a frozen dessert comprises mixing a liquid component, a dry component, and a substitution system to form a frozen dessert composition. The substitution system comprises a high intensity sweetener. The method further comprises freezing the frozen dessert composition into a frozen dessert.

The liquid component may comprise milk, cream, and corn syrup. The liquid component may comprise at least one of reduced lactose milk, reduced lactose cream, lactose-free milk, lactose-free cream, non-dairy milk, and non-dairy cream. The dry component may comprise milk powder and a traditional sweetener. The dry component may comprise at least one of reduced lactose milk powder, lactose-free milk powder, and non-dairy milk powder. The dry component may further comprise a stabilizer. The composition may further comprise other flavorings. The frozen dessert may comprise a semi-frozen frozen dessert. The method may further comprise freezing the frozen dessert to a hardening temperature. The hardening temperature may be between −20° F. and −50° F. A freezing point of the composition may be between 22.5° F. and 23.5° F. A freezing point of the composition may be within ±0.5° F. of a freezing point of an identical composition that includes traditional sweeteners and does not include a substitution system. The composition may further comprise ethyl alcohol. The substitution system may further comprise a bulking agent. The high intensity sweetener may be between 0.05 wt % and 1 wt %. The bulking agent may be between 5 wt % and 15 wt %. The ethyl alcohol may be between 3 wt % and 15 wt %. The high intensity sweetener may be selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof. The bulking agent may be selected from the group consisting of carbohydrates, corn syrup solids, proteins, and combinations thereof.

### BRIEF DESCRIPTION OF THE DRAWINGS

Various embodiments are depicted in the accompanying drawings for illustrative purposes, and should in no way be interpreted as limiting the scope of the embodiments. Furthermore, various features of different disclosed embodiments can be combined to form additional embodiments, which are part of this disclosure.

FIG. 1 is a flow chart of an example method of making a frozen dessert.

FIG. 2 is a flow chart of another example method of making a frozen dessert.

FIG. 3 is a graph comparing the freezing profiles of example frozen desserts.

FIG. 4 is a flow chart of another example method of making a frozen dessert.

FIG. 5 is a flow chart of another example method of making a frozen dessert.

FIG. 6 is a flow chart of another example method of making a frozen dessert.

### DETAILED DESCRIPTION

Consumers desire and expect certain taste (e.g., sweetness) and texture (e.g., creaminess, smoothness) qualities in their frozen dessert. Generally, smaller ice crystals in a frozen dessert provide more smoothness and large ice crystals in a frozen dessert provide less smoothness, creating an icy, coarse texture to the frozen dessert that is undesirable to consumers. Maintaining the desirable taste and texture qualities in the frozen dessert from manufacture to consumption by a consumer can enhance commercialization.

Consumers also desire new and novel flavors of frozen desserts. The ingredients used in frozen desserts to make new and novel flavors of frozen desserts can conflict with consumers' expectations of and desires for the taste and texture qualities of a frozen dessert because the ingredients can adversely affect the taste and texture qualities of the frozen dessert, and in turn affect the successful commercialization of a frozen dessert. Although common food additives such as stabilizers can be used to achieve the texture qualities desired by consumers, consumers are also increasingly wary of additives that are unfamiliar or perceived as “artificial.”

### Temperature

The freezing point of a composition is the temperature at which the composition transitions between a liquid and a solid. Freezing point depression (“FPD”) is the reduction of the freezing point of a composition caused by soluble components in the composition.

The FPD in degrees Celsius (° C.) of a soluble component (“FPD”) can be calculated from Equation 1:

$$FPD = K \frac{G}{M} \qquad Equation 1$$

in which
K is a solvent factor in (° C.)(1000 g water)/mol (where the solvent is water, K=1.86 (° C.)(1000 g water)/mol, but varies for different temperature and weight units);
G is grams of a soluble component per 1000 grams of water; and
M is the molecular weight of the soluble component in g/mol.

As an example, pure water would freeze at 32° F. (0° C.) under standard pressure (1 atm). Adding 100 grams of sucrose to 1000 grams of water would reduce the depress the freezing point of the sucrose solution by 0.54° C. to −0.54° C., or by 0.97° F. to 31.03° F. As another example, adding 200 grams of sucrose to 1000 grams of water would reduce the depress the freezing point of the sucrose solution by 1.08° C. to −1.08° C., or by 1.94° F. to 30.06° F. The more sucrose added, the more the freezing point is depressed.

The soluble components of a frozen dessert composition can each contribute to FPD in the composition. A way to determine the FPD due to multiple soluble components in a frozen dessert composition starts with calculating the sucrose temperature equivalence of each soluble component i (“STEᵢ”) using Equations 2 and 3:

STEᵢ=(% dissolved i by weight)×FPFᵢ Equation 2

in which

$${FPF}_{i} = \frac{342}{{M}_{i}} \qquad Equation 3$$

in which
FPFᵢ is the freezing point factor of soluble component i;
342 is the molecular weight of sucrose in g/mol; and
Mᵢ is the molecular weight of the soluble component i in g/mol.

The value of G from Equation 1 above can be calculated from STEi using Equation 4:

$$G = \frac{{\sum }_{i = 0}^{n} {STE}_{i}}{\% water in solution by weight} \times 100 \qquad Equation 4$$

Percentage of soluble component i by weight or weight percent (wt %) as used herein is defined by Equation 5:

$$\% i by weight = \frac{{W}_{i}}{{W}_{Total}} \times 100 \qquad Equation 5$$

in which
Wᵢ is the weight of soluble component i in the frozen dessert composition; and
W_{Total} is the total weight the frozen dessert composition.

If more soluble components such as ethyl alcohol are added, those soluble components can also contribute to the FPD in the composition such that, for example, the frozen dessert composition remains liquid at a temperature lower than the freezing point for a frozen dessert composition that does not include ethyl alcohol (e.g., about 23° F.). Absent any adjustments in an alcohol frozen dessert composition, the resulting alcohol frozen dessert cannot maintain the desirable taste and texture qualities that consumers expect under typical commercial conditions for the manufacture, sale, and consumption of frozen desserts.

### Components of a Frozen Dessert

In some embodiments, a frozen dessert composition comprises a liquid component, a dry component, a source of ethyl alcohol, and optionally other flavorings. The liquid component may optionally comprise corn syrup or sugar syrup, or may be derived from dairy (e.g., from cows or sheep), nuts (e.g., almond), grains (e.g., rice), legumes (e.g., soy), fruits (e.g., apple), plants (e.g., tea, coffee), combinations thereof, and/or the like. The dry component may comprise, for example, milk powder and sweeteners. Some other flavorings may comprise liquid extracts (e.g., vanilla extract), herbs (e.g., tarragon), spices (e.g., cinnamon), etc. The frozen dessert composition optionally comprises non-fat milk solids (MSNF or milk powder), bulking agents, stabilizers, and/or other ingredients. Such components can be added to the liquid component, the dry component, or separately as appropriate. In some embodiments, the frozen dessert composition comprises ethyl alcohol or a source of ethyl alcohol. Some of these components, in solution, can contribute to depressing the freezing point of the frozen dessert composition.

Additional components, such as nuts, candies (e.g., mints, chocolate), snack goods (e.g., pretzels, cookies), fruit-derived products (e.g., dried fruits, dehydrated fruits, candied fruits), and the like can be incorporated into the frozen dessert after it has been frozen.

Sweeteners

Frozen dessert compositions are typically sweet. A conventional commercial frozen dessert may contain between about 12 wt % and about 17 wt % sucrose. A traditional frozen dessert composition uses only traditional sweetener(s) to provide sweetness. As described above, traditional sweeteners such as sucrose can greatly contribute to depressing the freezing point of a traditional frozen dessert composition. Ethyl alcohol or ethanol or C₂H₆O or “alcohol” in the context of food consumption can also contribute to depressing the freezing point of a frozen dessert composition. The addition of both ethyl alcohol and traditional sweeteners can depress the freezing point of an alcohol-containing traditional frozen dessert to temperatures below the freezing point of frozen desserts not containing ethyl alcohol such that an alcohol-containing frozen dessert composition can remain unfrozen at typical commercial conditions but can be frozen at lower temperatures to maintain the desirable taste and texture qualities consumers expect. Certain such alcohol-containing traditional frozen desserts can be too expensive to be commercially viable.

Stabilizers can be added to an alcohol-containing traditional frozen dessert to approach desirable taste and texture qualities under typical commercial conditions, but consumers may be wary of the stabilizer content, and stabilizers may have other adverse effects (e.g., imparting a gelatinous mouthfeel).

If the goal is to produce a frozen dessert comprising alcohol that does not have too low a freezing point, the alcohol should not be removed. Removing or reducing sweetness could result in an unacceptable taste profile. As described in further detail herein, traditional sweeteners can be at least partially replaced by a substitution system. The use of the substitution system can reduce adverse effects on the resulting frozen dessert due to FPD caused by the addition of ethyl alcohol by manipulating the freezing point of the frozen dessert composition to temperatures typical of commercial frozen desserts not containing ethyl alcohol, and while maintaining the taste and texture qualities desired by consumers. In some embodiments, a substitution system comprises, or alternatively consists essentially of, one high intensity sweetener and one bulking agent. In some embodiments, a substitution system comprises, or alternatively consists essentially of, more than one high intensity sweetener. In some embodiments, a substitution system comprises, or alternatively consists essentially of, more than one bulking agent. In some embodiments, a substitution system comprises, or alternatively consists essentially of, a bulking agent. In some embodiments, a substitution system comprises, or alternatively consists essentially of, a high intensity sweetener.

Traditional sweeteners can include, for example, lactose, sucrose or “sugar,” corn syrups or corn syrup solids, high-maltose corn syrups, high-fructose corn syrups, glucose or dextrose, fructose, honey sugar alcohols, combinations thereof, and/or the like. Frozen desserts are typically sweet, so the quantity of traditional sweeteners used to produce a desirable sweetness can have a high impact on FPD. The traditional sweetener may be present, for example, at less than about 15 wt %, between about 2.5 wt % and about 12.5 wt %, or between about 5 wt % and about 10 wt %.

In a substitution system, some of a traditional sweetener can be at least partially replaced by a high intensity sweetener (“HIS”). In some embodiments, a HIS comprises, for example, aspartame, acesulfame-K, alitame, brazzein, cyclamate, dihydrochalcones (DHCs), monk fruit extract, Neo DHC, neotame, sucralose, stevia and stevia derivatives, saccharine, thaumatin, combinations thereof, and/or the like. The HIS can be natural (e.g., occurring in nature, even if processed to result in the HIS, such as stevia), artificial (e.g., not occurring in nature or made through an artificial manufacturing process, such as cyclamate), and/or combinations thereof. In some embodiments, the HIS is present in the frozen dessert composition at less than about 1 wt %, less than about 0.5 wt %, or less than about 0.05 wt %. In each case, the HIS would be present at greater than 0%. In some embodiments, the frozen dessert composition comprises HIS between about 0.01 wt % and about 2 wt % (e.g., about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.25 wt %, about 0.5 wt %, about 0.75 wt %, about 1 wt %, ranges between such values, etc.), although wt % HIS may vary depending on the HIS.

The sweetness of a traditional sweetener or an HIS will vary depending on the sweetener. Sucrose Sweetness Equivalence (SSE) is a comparative value that can be used to compare the relative sweetness of different sweeteners. By way of example, with the SSE of sucrose set at 1, a sweetener that is twice as sweet as sucrose has an SSE of 2 and a sweetener that is half as sweet as sucrose has an SSE of 0.5. Tables 1 and 2 below lists the SSE of various sweeteners.

TABLE 1
Traditional Sweetener SSE

| Sweetener | SSE | Sweetener | SSE |
|---|---|---|---|
| 40% high-maltose corn syrup | 0.50 | Lactitol | 0.30-0.40 |
| 65% high-maltose corn syrup | 0.45 | Lactose | 0.20 |
| 42% high-fructose corn syrup | 0.90-1.00 | Maltitol | 0.90 |
| 55% high-fructose corn syrup | 1.10-1.20 | Maltitol syrup | 0.65 |
| 90% high-fructose corn syrup | 1.20-1.40 | Maltodextrin, | 0.10 |
| | | 10 DE | |
| Corn syrup, 36, 42 DE | 0.45 | Mannitol | 0.45 |
| Dextrose | 0.80 | Medium invert | 1.05 |
| | | sugar | |
| Erthyritol | 0.45-0.50 | Polyglycitol | Varies |
| Fructose | 1.20-1.60 | Sorbitol | 0.50 |
| Glycerol | 0.55-0.75 | Sucrose (Sugar) | 1.00 |
| Invert sugar | 1.10 | Xylitol | 0.85-1.00 |

TABLE 2
High Intensity Sweetener SSE

| Sweetener | SSE | Sweetener | SSE |
|---|---|---|---|
| Acesulfame K | 200 | Monk fruit extract | 300-400 |
| Alitame | 2,000 | Neo DHC | 150 |
| Aspartame | 200 | Neotame | 2,000-8,000 |
| Brazzein | 2,000 | Saccharine | 300-400 |
| Cyclamate | 30-60 | Stevia (Rebiana) | 300-600 |
| Dihydrochalones (DHCs) | 300-2,000 | Sucralose | 600 |
| Glycyrrhizin | 50-100 | Thaumatin | 1,500-2,000 |

Sweeteners with SSE greater than one can provide the same level of sweetness to a frozen dessert as sucrose in a lower quantity than sucrose. For example, 1 gram of aspartame with SSE 200 can impart the same amount of sweetness as 200 grams of sucrose. The substitution of aspartame for sucrose in a frozen dessert composition can affect FPD. For example, assuming that the soluble component(s) being calculated completely dissolves in the composition, the following three calculations can provide a useful comparison.

Calculation 1:

1000 grams of frozen dessert composition includes 500 grams of water, 200 grams of sucrose to achieve an SSE of 200, and 300 grams of other components (e.g., milk fat). The FPD caused by sucrose (FPD_{sucrose}) can be calculated using Equations 1 to 5 as follows:

$${M}_{sucrose} = 342 g \text{/} mol \\ [ Equation 5 ] wt \% water = 500 / 1000 \times 100 = 50 \\ [ Equation 5 ] wt \% sucrose = 200 / 1000 \times 100 = 20 \\ [ Equation 3 ] {FPF}_{sucrose} = 342 / 342 = 1 \\ [ Equation 2 ] {STE}_{sucrose \text{-} 1} = ( wt \% sucrose ) ( {FPF}_{sucrose} ) = 20 \times 1 = 20 \\ [ Equation 4 ] {G}_{sucrose \text{-} 1} = {STE}_{sucrose \text{-} 1} / wt \% water \times 100 = 20 / 50 \times 100 = 40$$

$$\begin{matrix}[ Equation 1 ] {FPD}_{sucrose} = K \times {G}_{sucrose \text{-} 1} / {M}_{sucrose} \\ = 1.86 \times 40 / 342 \\ = 0.22 ° C . ( 0.4 ° F . )\end{matrix}$$

Calculation 2:

Half of the sucrose in the frozen dessert composition in Calculation 1 above is replaced with aspartame, which has an SSE of 200. To achieve the same SSE of 200, the modified frozen dessert composition has 100 grams of sucrose and 0.5 gram of aspartame. All else equal, the modified frozen dessert composition weighs 900.5 grams. The FPD of the modified frozen dessert composition (FPD_{sucrose, aspartame}) can be calculated using Equations 1-5 as follows:

$${M}_{sucrose} = 342 g \text{/} mol$$

$${M}_{aspartame} = 294 g \text{/} mol \\ [ Equation 5 ] wt \% water = 500 / 900.5 \times 100 = 56 \\ [ Equation 5 ] wt \% sucrose = 100 / 900.5 \times 100 = 11 \\ [ Equation 5 ] wt \% aspartame = 0.5 / 900.5 \times 100 = 0.056 \\ [ Equation 3 ] {FPF}_{sucrose} = 342 / 342 = 1 \\ [ Equation 3 ] {FPF}_{aspartame} = 342 / 294 = 1.16 \\ [ Equation 2 ] {STE}_{sucrose \text{-} 2} = ( wt \% sucrose ) ( {FPF}_{sucrose} ) = 11 \times 1 = 11$$

$$\begin{matrix}[ Equation 2 ] {STE}_{aspartame \text{-} 2} = ( wt \% aspartame ) ( {FPF}_{aspartame} ) \\ = 0.056 \times 1.16 \\ = 0.048\end{matrix}$$

$$\begin{matrix}[ Equation 4 ] {G}_{sucrose , aspartame } = \frac{{STE}_{sucrose \text{-} 2} + {STE}_{aspartame \text{-} 2}}{wt \% water} \times 100 \\ = ( 11 + 0.048 ) / 56 \times 100 \\ = 20\end{matrix}$$

$$\begin{matrix}[ Equation 1 ] {FPD}_{sucrose , aspartame} = K \times {G}_{sucrose , aspartame} / {M}_{sucrose} \\ = 1.86 \times 20 / 342 \\ = 0.11 ° C . ( 0.2 ° F . )\end{matrix}$$

Calculation 3:

All of the sucrose in the frozen dessert composition in Calculation 1 above is replaced with aspartame. As discussed above, to achieve the same SSE of 200, the modified frozen dessert composition has 1 gram of aspartame. All else equal, the modified frozen dessert composition weighs 801 grams. The FPD of the modified frozen dessert composition (FPDₐₛₚₐᵣₜₐₘₑ) can be calculated using Equations 1-5 as follows:

$${M}_{sucrose} = 342 g \text{/} mol$$

$${M}_{aspartame} = 294 g \text{/} mol \\ [ Equation 5 ] wt \% water = 500 / 801 \times 100 = 62 \\ [ Equation 5 ] wt \% aspartame = 1 / 801 \times 100 = 0.12 \\ [ Equation 3 ] {FPF}_{aspartame} = 342 / 294 = 1.16 \\ [ Equation 2 ] {STE}_{aspartame \text{-} 3} = ( wt \% aspartame ) ( {FPF}_{aspartame} ) = 0.12 \times 1.16 = 0.14 \\ [ Equation 4 ] {G}_{aspartame \text{-} 3} = {STE}_{aspartame \text{-} 3} / wt \% water \times 100 = 0.14 / 62 \times 100 = 0.22$$

$$\begin{matrix}[ Equation 1 ] {FPD}_{aspartame} = K \times {G}_{aspartame \text{-} 3} / {M}_{sucrose} \\ = 1.86 \times 0.22 / 342 \\ = 0.001 ° C . ( 0.002 ° F . )\end{matrix}$$

The FPD due to a traditional sweetener can thereby be reduced by using HIS to replace sweetness lost by partial to complete removal of the traditional sweetener from a frozen dessert composition. The relative ratios of traditional sweetener to HIS can be determined using SSE. In some embodiments in which traditional sweetener was limited due to FPD even if consumers would have preferred a sweeter frozen dessert, the reduction in FPD provided by HIS may allow higher sweetness.

Other soluble components of the frozen dessert may also contribute sweetness and can also be used in an overall sweetness calculation, but the sweetness of those soluble components may remain constant such that the calculation may primarily or only consider the SSE of the soluble component (e.g., sucrose) being at least partially replaced by HIS. At the very least, the amount that those soluble components depress the freezing point is constant such that the FDP due to sweeteners can be usefully compared.

For clarity, the FPD in each of Calculations 1-3 is not the sole contributor to the final freezing point of the frozen dessert composition, for example because other soluble ingredients or components can also contribute to the depression of the freezing point. Rather, the calculated FPD is the depression of the freezing point that can be attributed to, for example, based on Calculations 1 through 3 above, (1) sucrose, (2) sucrose and aspartame, or (3) aspartame alone. The sucrose may be a large contributor to depression of freezing point, so reducing its effects by two to four orders of magnitude can have a substantial impact on the overall freezing point. A freezing point that accounts for all soluble ingredients or components of a frozen dessert composition can be calculated based on the equations provided herein and/or commercially available software.

Bulking Agents

Bulking agents can contribute to the level of total solids in a frozen dessert composition and to the viscosity and cohesiveness of the frozen dessert composition. Bulking agents can contribute the texture or “mouthfeel” consumers expect and desire of a frozen dessert. Bulking agents can contribute to the melting behavior of a frozen dessert and the management of the growth of ice crystals in a frozen dessert.

If a traditional sweetener is at least partially replaced using a HIS, the frozen dessert may still lack features that consumers may associate with a frozen dessert that may be attributable to traditional sweeteners. For example, sucrose can act as a bulking agent that can contribute to the texture and mouthfeel of a frozen dessert, as well as acting as a sweetener. The reduction of the amount of traditional sweetener, for example in an effort to reduce FPD, can make the resulting frozen dessert composition less smooth and rich. In a frozen dessert composition in which the traditional sweetener is at least partially replaced using a HIS, the reduction in quality of the texture of the frozen dessert composition can be at least partially remedied by a substitution system comprising a bulking agent.

The bulking agent can comprise, for example, certain carbohydrates (e.g., rice starch, corn starch, tapioca starch, potato starch, other starches, corn syrup solids, maltodextrins, polydextrose, polyglycitols, oligosaccharides (e.g., gluco-oligosaccharides)), certain proteins (derived from, e.g., dairy, egg, vegetable), combinations thereof, and/or the like. The bulking agent can be natural (e.g., occurring in nature, even if process to result in the bulking agent, such as corn syrup solids), artificial (e.g., not occurring in nature or made through an artificial manufacturing process, such as polydextrose). In some embodiments, the bulking agent of the substitution system is present in the frozen dessert composition at less than about 10 wt %, less than about 8 wt %, or less than about 5 wt %. In each case, the bulking agent would be present at greater than 0%. In some embodiments, the frozen dessert composition comprises bulking agent of the substitution system between about 1 wt % and about 20 wt % (e.g., about 1 wt %, about 2 wt %, about 2.5 wt %, about 3 wt %, about 3.5 wt %, about 4 wt %, about 5 wt %, about 6 wt %, about 8 wt %, about 10 wt %, about 15 wt %, about 20 wt %, ranges between such values, etc.), although wt % bulking agent may vary depending on the bulking agent.

Ethyl Alcohol

Sources of ethyl alcohol can include, without limitation, beer, wine, cider, mezcal, rum, tequila, whiskey, scotch whiskey, brandy, vodka, gin, mead, flavored liqueurs (e.g., coffee, cream, crème, chocolate, honey, nut, fruit, flower, herb, etc.), combinations thereof, and/or the like. As discussed above, ethyl alcohol causes FPD in a frozen dessert composition. In some embodiments, the ethyl alcohol is present in the frozen dessert composition at between about 3 wt % and about 20 wt % (e.g., about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 15 wt %, about 18 wt %, about 20 wt %, ranges between such values, etc.). The amount of ethyl alcohol does not refer to the percent of ethyl alcohol present in the source of ethyl alcohol, which can vary by source type.

Continuing from the example calculations presented in Calculations 1 through 3 above, the following three examples provide additional useful comparison of the FPD effect of ethyl alcohol (“EtOH”).

Calculation 4:

Calculation 1 considered a composition wherein 1000 grams of frozen dessert composition included 500 grams of water, 200 grams of sucrose to achieve an SSE of 200, and 300 grams of other components (e.g., milk fat). If 100 grams of ethyl alcohol were added to the frozen dessert composition of Calculation 1 for a total weight of 1100 grams, the FPD caused by the combination of sucrose and ethyl alcohol (FPD_{sucrose, EtOH}) can be calculated using Equations 1 to 5 as follows:

$${M}_{sucrose} = 342 g \text{/} mol$$

$${M}_{EtOH} = 46 g \text{/} mol \\ [ Equation 5 ] wt \% water = 500 / 1100 \times 100 = 45 \\ [ Equation 5 ] wt \% sucrose = 200 / 1100 \times 100 = 18 \\ [ Equation 5 ] wt \% EtOH = 100 / 1100 \times 100 = 9 [ Equation 3 ] {FPF}_{sucrose} = 342 / 342 = 1 \\ [ Equation 3 ] {FPF}_{EtOH} = 342 / 46 = 7.4 \\ [ Equation 2 ] {STE}_{sucrose \text{-} 4} = ( wt \% sucrose ) ( {FPF}_{sucrose} ) = 18 \times 1 = 18 \\ [ Equation 2 ] {STE}_{EtOH \text{-} 4} = ( wt \% EtOH ) ( {FPF}_{EtOH} ) = 9 \times 7.4 = 67$$

$$\begin{matrix}[ Equation 4 ] {G}_{sucrose , EtOH} = \frac{{STE}_{sucrose \text{-} 4} + {STE}_{EtOH \text{-} 4}}{wt \% water} \times 100 \\ = ( 18 + 67 ) / 45 \times 100 \\ = 190\end{matrix}$$

$$\begin{matrix}[ Equation 1 ] {FPD}_{sucrose , EtOH} = K \times {G}_{sucrose , EtOH} / {M}_{sucrose} \\ = 1.86 \times 190 / 342 \\ = 1.0 ° C . ( 1.8 ° F . )\end{matrix}$$

FPD_{sucrose} in Calculation 1 was 0.22° C. (0.4° F.), so the effect of ethanol on the FPD_{sucrose, EtOH} is significant.

Calculation 5:

Calculation 2 considered a composition wherein half of the sucrose in the frozen dessert composition in Calculation 1 was replaced with aspartame. To achieve the same SSE of 200, the modified frozen dessert composition had 100 grams of sucrose and 0.5 gram of aspartame. All else equal, the modified frozen dessert composition weighed 900.5 grams. If 100 grams of ethyl alcohol were added to the modified frozen dessert composition of Calculation 2 for a total weight of 1000.5 grams, the FPD of the modified frozen dessert composition (FPD_{sucrose, aspartame, EtOH}) can be calculated using Equations 1-5 as follows:

$${M}_{sucrose} = 342 g \text{/} mol$$

$${M}_{aspartame} = 294 g \text{/} mol$$

$${M}_{EtOH} = 46 g \text{/} mol \\ [ Equation 5 ] wt \% water = 500 / 1000.5 \times 100 = 50 \\ [ Equation 5 ] wt \% sucrose = 100 / 1000.5 \times 100 = 10 \\ [ Equation 5 ] wt \% aspartame = 0.5 / 1000.5 \times 100 = 0.05 \\ [ Equation 5 ] wt \% EtOH = 100 / 1000.5 \times 100 = 10 [ Equation 3 ] {FPF}_{sucrose} = 342 / 342 = 1 \\ [ Equation 3 ] {FPF}_{aspartame} = 342 / 294 = 1.16 \\ [ Equation 3 ] {FPF}_{EtOH} = 342 / 46 = 7.4 \\ [ Equation 2 ] {STE}_{sucrose \text{-} 5} = ( wt \% sucrose ) ( {FPF}_{sucrose} ) = 10 \times 1 = 10$$

$$\begin{matrix}[ Equation 2 ] {STE}_{aspartame \text{-} 5} = ( wt \% aspartame ) ( {FPF}_{aspartame} ) \\ = 0.05 \times 1.16 \\ = 0.058\end{matrix} \\ [ Equation 2 ] {STE}_{EtOH \text{-} 5} = ( wt \% EtOH ) ( {FPF}_{EtOH} ) = 10 \times 7.4 = 74$$

$$\begin{matrix}[ Equation 4 ] {G}_{sucrose , aspartame , EtOH} = \frac{\begin{matrix}{STE}_{sucrose \text{-} 5} + \\ {STE}_{aspartame \text{-} ε} + {STE}_{EtOH \text{-} 5}\end{matrix}}{wt \% water} \times 100 \\ = ( 10 + 0.058 + 74 ) / 56 \times 100 \\ = 150\end{matrix}$$

$$\begin{matrix}[ Equation 1 ] {FPD}_{sucrose , aspartame , EtOH} = K \times {G}_{sucrose , aspartame , EtOH} / {M}_{sucrose} \\ = 1.86 \times 150 / 342 \\ = 0.82 ° C . ( 1.47 ° F . )\end{matrix}$$

FPD_{sucrose, aspartame} in Calculation 2 was 0.11° C. (0.2° F.), so the effect of ethanol on the FPD_{sucrose, aspartame, EtOH} is Significant.

Calculation 6:

Calculation 3 considered a composition wherein all of the sucrose in the frozen dessert composition in Calculation 1 above was replaced with aspartame. As discussed above, to achieve the same SSE of 200, the modified frozen dessert composition has 1 gram of aspartame. All else equal, the modified frozen dessert composition weighed 801 grams. If 100 grams of ethyl alcohol were added to this modified frozen dessert composition of Calculation 3 for a total weight of 901 grams, the FPD of the modified frozen dessert composition (FPD_{aspartame, EtOH}) can be calculated using Equations 1-5 as follows:

$${M}_{sucrose} = 342 g \text{/} mol$$

$${M}_{aspartame} = 294 g \text{/} mol$$

$${M}_{EtOH} = 46 g \text{/} mol \\ [ Equation 5 ] wt \% water = 500 / 901 \times 100 = 55 \\ [ Equation 5 ] wt \% aspartame = 1 / 901 \times 100 = 0.11 \\ [ Equation 5 ] wt \% EtOH = 100 / 901 \times 100 = 11.1 \\ [ Equation 3 ] {FPF}_{aspartame} = 342 / 294 = 1.16 \\ [ Equation 3 ] {FPF}_{EtOH} = 342 / 46 = 7.4$$

$$\begin{matrix}[ Equation 2 ] {STE}_{aspartame \text{-} 6} = ( wt \% aspartame ) ( {FPF}_{aspartame} ) \\ = 0.11 \times 1.16 \\ = 0.13\end{matrix} \\ [ Equation 2 ] {STE}_{EtOH \text{-} 6} = ( wt \% EtOH ) ( {FPF}_{EtOH} ) = 11.1 \times 7.4 = 82$$

$$\begin{matrix}[ Equation 4 ] {G}_{aspartame , EtOH} = \frac{{STE}_{aspartame \text{-} 6} + {STE}_{EtOH \text{-} 6}}{wt \% water} \times 100 \\ = ( 0.13 + 82 ) / 55 \times 100 \\ = 149\end{matrix}$$

$$\begin{matrix}[ Equation 1 ] {FPD}_{aspartame , EtOH} = K \times {G}_{aspartame , EtOH \text{-} 6} / {M}_{sucrose} \\ = 1.86 \times 149 / 342 \\ = 0.81 ° C . ( 1.46 ° F . )\end{matrix}$$

FPDₐₛₚₐᵣₜₐₘₑ in Calculation 3 was 0.001° C. (0.002° F.), so the effect of ethanol accounts for almost all of the FPD_{aspartame, EtOH}.

As can be appreciated by those skilled in the art, the FPD effect of ethyl alcohol in a frozen dessert composition dwarfs the FPD effect of other soluble components in a frozen dessert composition, for example, sucrose or aspartame. If the goal is the make an alcohol-containing frozen dessert composition that does not have too low of a freezing point, the FPD effect of the alcohol can be controlled by at least partially replacing the traditional sweeteners in a frozen dessert composition with a substitution system to manipulate the freezing point of the frozen dessert composition to temperatures typical of commercial frozen desserts, and while maintaining the taste and texture qualities desired by consumers.

### EXAMPLES

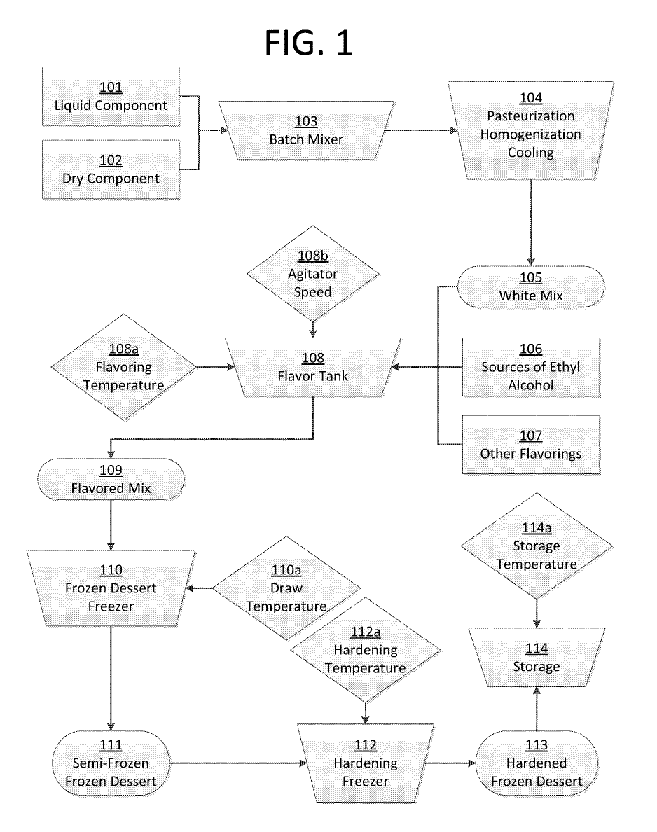

Each of the shapes used in FIGS. 1-5 represents a different aspect of the process. Rectangles, a four-sided flat shape wherein each internal angle is 90° and opposite sides are parallel and of equal length, denote the various components of a frozen dessert composition as described above. Trapezoids, a four-sided flat shape wherein only one pair of opposite sides are parallel and wherein the non-parallel sides are of equal length, denote unit operations, for example batch mixers, pasteurizers, homogenizers, coolers, various tanks, freezers, storage, etc. Long ovals, a flat shape wherein one pair of opposite sides of equal length are straight and parallel, and one pair of opposite sides are of equal length and arcuate such that each side curves inward, denote products and interim products resulting from the unit operations denoted with a trapezoid. Diamonds, a four-sided flat shape wherein one pair of opposite corners have an obtuse angle, wherein the second pair of opposite corners have an acute angle, and wherein all four sides are of equal length, denote operating parameter inputs for certain unit operations.

### Example 1

FIG. 1 is a flow chart of an example method of making an alcohol-containing frozen dessert using a traditional sweetener. The liquid component at 101 can comprise, for example, milk, cream, concentrated dairy products, corn syrup, and sugar syrup. The dry component at 102 can comprise, for example, milk powder, sucrose, and stabilizer. The liquid component at 101 and the dry component at 102 are combined in a batch mixer at 103. The resulting mixture is pasteurized, homogenized, and cooled in unit operations collectively represented by the trapezoid at 104. The pasteurized, homogenized, and cooled mixture is referred to as the “White Mix” at 105.

In some embodiments, the components making up the liquid component at 101 are combined before the liquid component at 101 is added to the batch mixer at 103. In some embodiments, the components making up the liquid component at 101 are added separately or in different combinations into the batch mixer at 103. In some embodiments, the components making up the dry component at 102 are combined before the dry component at 102 is added to the batch mixer at 103. In some embodiments, components making up the dry component at 102 are added separately or in different combinations into the batch mixer at 103.

The white mix at 105 is combined with sources of alcohol at 106 and other flavorings at 107 in a flavor tank at 108. The sources of ethyl alcohol at 106 may comprise, for example, vodka and coffee liqueur. A single source of ethyl alcohol is also possible. In some embodiments, multiple sources of ethyl alcohol are combined before sources of ethyl alcohol are added to the flavor tank at 108. In some embodiments, multiple sources of ethyl alcohol are added separately or in different combinations into the flavor tank at 108.

The processes described herein are not limited to the order described in the example methods, and the combinations discussed with respect to 105, 106, and 107 may be reordered, combined, reversed, etc. For example, the white mix at 105 can be combined with the sources of ethyl alcohol at 106 before combining the white mix with the optional other flavorings at 107. For another example, the white mix at 105 can be combined with the other flavorings at 107 before combining both with the sources of ethyl alcohol at 108. For another example, part of or all of the sources of ethyl alcohol at 106 can be combined with part of or all of the other flavorings at 107, which can then be combined with the remainder or another part of the sources of ethyl alcohol at 106 and/or the other flavorings at 107.

During mixing in the flavor tank at 108, the tank is maintained at a fixed flavoring temperature input at 108a and a fixed agitator speed input at 108b. In some embodiments, the flavoring temperature and/or the agitator speed may vary (e.g., ramping up, ramping down, etc.) during the mixing. In some embodiments, the flavoring temperature input at 108a is ranges from 41° F. to 53° F. and the agitator speed of the flavor tank at 108b is between 10,000 revolutions per minute (rpm) and 20,000 rpm. The white mix at 105, the sources of ethyl alcohol at 106, and the other flavorings at 107 are combined until substantially uniform in the flavor tank to result in the flavored mix at 109. If the energy due to mixing, heats of dissolution, etc. would otherwise cause the flavored mix at 109 to increase in temperature, the flavor tank at 108 may include features to reduce or offset such temperature increases. For example, the flavoring temperature input at 108a may compensate for such effects.

The flavored mix at 109 is transferred into a frozen dessert freezer at 110. In some embodiments, the flavored mix 109 has a freezing point between about 21° F. and about 23° F., which may be depressed from a typical frozen dessert composition freezing point of about 23° F. due to the ethanol. The frozen dessert freezer is maintained at a fixed draw temperature, or exit temperature input, at 110a to form a semi-frozen frozen dessert at 111. In some embodiments, the draw temperature may vary (e.g., ramping up, ramping down, etc.) during the freezing. In some embodiments, the draw temperature input at 110a is between 18° F. and 24° F. In some embodiments, the difference between the flavoring temperature input at 108a and the draw temperature input at 110a is reduced or minimized, which may facilitate more efficient temperature reduction of the flavored mix at 109 into the semi-frozen frozen dessert at 111 by the frozen dessert freezer at 110. In some embodiments, the difference in temperature between the flavoring temperature input at 108a and the draw temperature input at 110a is between about 5° F. and about 25° F. (e.g., about 5° F., about 10° F., about 15° F., about 20° F., about 25° F. ranges between such values, etc.). As noted above, the flavoring temperature at 108a and/or the draw temperature at 110a may be less than a traditional frozen dessert composition due to the FPD of the ethyl alcohol. The semi-frozen frozen dessert at 111 may be consumed immediately. Alternatively, the semi-frozen frozen dessert at 111 may be transferred to a hardening freezer at 112, which is maintained at a fixed hardening temperature input at 112a to form a hardened frozen dessert at 113. In some embodiments, the hardening temperature input at 112a is maintained at about −20° F. The hardened frozen dessert at 113 may be stored in storage at 114, which is maintained at a fixed storage temperature input at 114a. In some embodiments, the storage temperature input at 114a is maintained at about −20° F. to −10° F. From storage at 114, the hardened frozen dessert at 113 is ready for shipment, sale, and/or consumption.

### Example 2

Other than the substitution system replacing some of the sucrose, the components in Example 2 are the same as the components in Example 1. This includes whole milk, heavy whipping cream, corn syrup (42DE), skim milk powder (no Vitamin A added), and stabilizer. The substitution system of Example 2 comprises HIS and a bulking agent. The quantity of HIS is calculated to have the same SSE as the amount of sucrose that is replaced. For example, if 3.9 g sucrose out of a total of 52.23 g sucrose in Example 1 is replaced by stevia having SSE of 300, then the substitution system comprises 0.013 g stevia. Since only 3.9 g sucrose is replaced, Example 2 still comprises 47.33 g sucrose. The quantity of bulking agent may be calculated based on the amount of sucrose that is replaced. For example, if 3.9 g sucrose is replaced by HIS for sweetness and the substitution system comprises a bulking agent comprising maltodextrin (10DE), then the substitution system comprises 24.883 g maltodextrin (10DE).

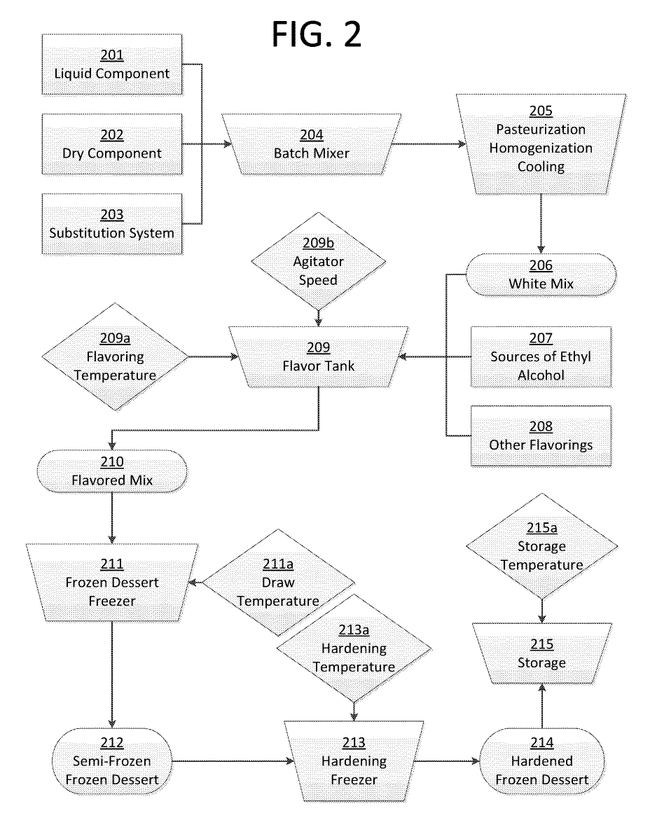

FIG. 2 is a flow chart of an example method of making an alcohol-containing frozen dessert using a substitution system. Liquid component at 201 can comprise, for example, milk, cream, concentrated dairy products, corn syrup, and sugar syrup. The dry component at 202 can comprise, for example, milk powder, sucrose, and stabilizer. The substitution system at 203 can comprise, for example, bulking agent (e.g., maltodextrin) and HIS (e.g., stevia). Liquid component at 201, dry component at 202, and substitution system at 203 are combined in a batch mixer at 204. The resulting mixture is pasteurized, homogenized, and cooled in unit operations collectively represented by the trapezoid at 205. The pasteurized, homogenized, and cooled mixture is referred to as “White Mix” at oval 206.

In some embodiments, the components making up the liquid component at 201 are combined before the liquid component at 201 is added to the batch mixer at 204. In some embodiments, the components making up the liquid component at 201 are added separately or in different combinations into the batch mixer at 204. In some embodiments, the components making up the dry component at 202 are combined before the dry component at 202 is added to the batch mixer at 204. In some embodiments, components making up the dry component at 202 are added separately or in different combinations into the batch mixer at 204. In some embodiments, the components making up the substitution system at 203 are combined before the substitution system at 203 is added to the batch mixer at 204. In some embodiments, the components making up the substitution system at 203 are added separately or in different combinations into the batch mixer at 204.

The processes described herein are not limited to the order described in the example methods, and the combinations discussed with respect to 201, 202, and 203 may be reordered, combined, reversed, etc. For example, the liquid component at 201 can be combined with the dry component at 202 before combining with the substitution system at 203. For another example, the liquid component at 201 can be combined with the substitution system at 203 before combining both with the dry component at 202. For another example, part of or all of the liquid component at 201 can be combined with part of or all of the dry component at 202, which can then be combined with the remainder or another part of the liquid component at 201 and/or the dry component at 202.

The white mix at 206 is combined with sources of alcohol at 207 and other flavorings at 208 in a flavor tank at 208. The sources of ethyl alcohol at 207 may comprise, for example, vodka and coffee liqueur. A single source of ethyl alcohol is also possible. In some embodiments, multiple sources of ethyl alcohol are combined before sources of ethyl alcohol are added to the flavor tank at 209. In some embodiments, multiple sources of ethyl alcohol are added separately or in different combinations into the flavor tank at 209.

The processes described herein are not limited to the order described in the example methods, and the combinations discussed with respect to 206, 207, and 208 may be reordered, combined, reversed, etc. For example, the sources of ethyl alcohol at 207 can be combined with the white mix at 206 before combining the white mix with the optional other flavorings at 208. For another example, the sources of ethyl alcohol at 207 can be combined with the other flavorings at 208 before combining both with the sources of ethyl alcohol at 207. For another example, part of or all of the white mix at 206 can be combined with part of or all of the sources of ethyl alcohol at 207, which can then be combined with the remainder or another part of the white mix at 206 and/or the sources of ethyl alcohol at 207. For another example, part or all of the other flavorings at 208 can be combined with part or all of the white mix at 206 and/or part or all of the sources of alcohol at 207, which can then be combined with the remainder or another part of the white mix at 206 and/or the sources of ethyl alcohol at 207.

During mixing in the flavor tank at 209, the mixer is maintained at a fixed flavoring temperature input at 209a and a fixed agitator speed input at 209b. In some embodiments, the flavoring temperature and/or the agitator speed may vary (e.g., ramping up, ramping down, etc.) during the mixing. In some embodiments, the flavoring temperature input at 209a is between about 24° F. and about 77° F. (e.g., about 24° F., about 25° F., about 26° F., about 28° F., about 30° F., about 32° F., about 35° F., about 40° F., about 45° F., about 50° F., about 55° F., about 60° F., about 65° F., about 70° F., about 75° F., about 77° F., ranges between such values, etc.). In some embodiments, the flavoring temperature input at 209a is greater than the freezing point of the frozen dessert composition (e.g., greater than about 23° F., about 24° F., about 25° F., about 26° F., etc.). In some embodiments, the flavoring temperature input at 209a is greater than the freezing point of water at standard pressure (32° F.). In some embodiments, the flavoring temperature input at 205a is less than standard room temperature. In most settings, standard temperature is 77° F., but in the context of making frozen dessert compositions, standard temperature may be less than 77° F. (e.g., about 75° F., about 70° F., about 65° F., about 60° F., about 55° F., about 50° F., etc.). Mixing between the freezing point of the frozen dessert composition and room temperature may, for example, better integrate the sources of ethyl alcohol into the frozen dessert composition. In some embodiments, the agitator speed input at 209b is between 10,000 rpm and 20,000 rpm. The white mix at 206, the sources of ethyl alcohol at 207, and the other flavorings at 208 are combined until substantially uniform in the flavor tank at 209 to result in the flavored mix at 210. If the energy due to mixing, heats of dissolution, etc. would otherwise cause the flavored mix at 210 to increase in temperature, the batch mixer may include features to reduce or offset such temperature increases. For example, the mixing temperature input 209a may compensate for such effects.

The flavored mix at 210 is transferred into a frozen dessert freezer at 211. In some embodiments, the flavored mix 210 has a freezing point of ±0.5° F. of 23° F., which is a typical freezing point for non-alcoholic frozen dessert compositions. In some embodiments, the flavored mix 210 has a freezing point between about 23° F. and about 24° F. The frozen dessert freezer is maintained at a fixed draw temperature, or exit temperature, input at 211a to form a semi-frozen frozen dessert at 212. In some embodiments, the draw temperature may vary (e.g., ramping up, ramping down, etc.) during the freezing. In some embodiments, the draw temperature input at 211a is between 18° F. and 24° F. In some embodiments, the difference between the flavoring temperature input at 209a and the draw temperature input at 211a is reduced or minimized, which may facilitate more efficient temperature reduction of the flavored mix at 210 into the semi-frozen frozen dessert at 212 by the frozen dessert freezer at 211. In some embodiments, the difference in temperature between the flavoring temperature input at 209a and the draw temperature input at 211a is between about 5° F. and about 25° F. (e.g., about 5° F., about 10° F., about 15° F., about 20° F., about 25° F., ranges between such values, etc.). As noted above, the flavoring temperature at 209a and/or the draw temperature at 211a may be less than a traditional frozen dessert composition due to the FPD of the ethyl alcohol, but not as low as in Example 1 because the FPD has been reduced by partial replacement of the sucrose with HIS in the substitution system. The semi-frozen frozen dessert at 212 may be consumed immediately. Alternatively, the semi-frozen frozen dessert at 212 may be transferred to the hardening freezer at storage at 213, which is maintained at a fixed hardening temperature input at 213a to form a hardened frozen dessert at 214. In some embodiments, the hardening temperature input at 213a is maintained at less than about −20° F. In some embodiments, the hardening temperature input at 213a is between about −20° F. and about −50° F. (e.g., about −20° F., about −25° F., about −30° F., about −35° F., about −40° F., about −45° F., about −50° F., ranges between such values, etc.). The hardened frozen dessert at 214 may be stored in storage at 215, which is maintained at a fixed storage temperature at 215a. In some embodiments, the storage temperature input at 215a is maintained at about −20° F. to −10° F. From storage at 215, the hardened frozen dessert at 214 is ready for shipment, sale, and/or consumption.

The freezing point of the flavored mix of Example 2 is within 0.25° F. of the freezing point of the flavored mix of Example 1. In some embodiments, the amount of sucrose or other traditional sweetener replaced with the substitution system is configured to maintain the freezing point of the flavored mix within about 1° F., about 0.75° F., about 0.5° F., or about 0.25° F. of the freezing point of the same frozen dessert composition if no sucrose or other traditional sweetener was replaced.

### Comparison of Examples 1 and 2

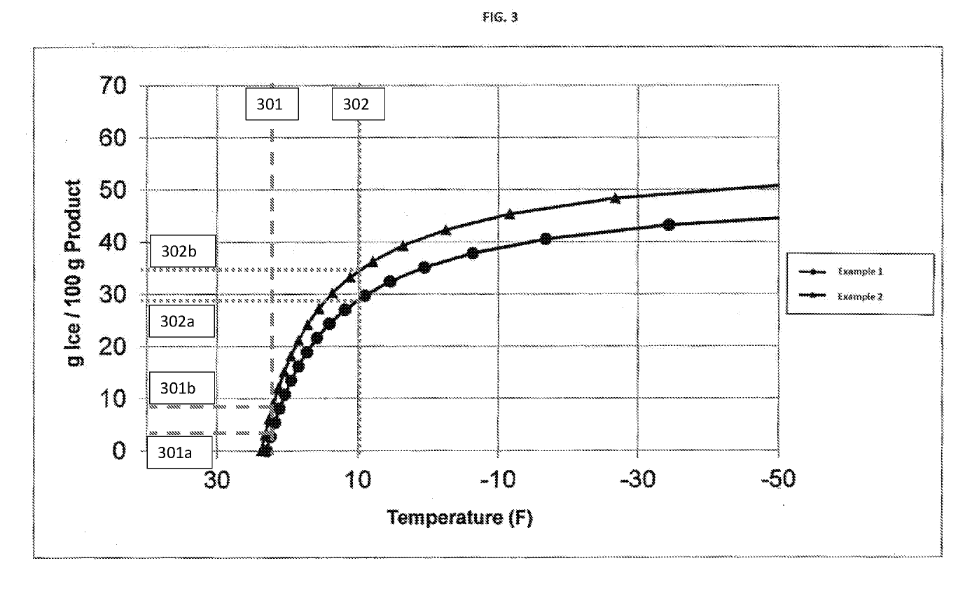

FIG. 3 is a graph comparing the freezing profiles of the white mixes (before combination with sources of ethyl alcohol) of Examples 1 and 2. More specifically, FIG. 3 is a plot of grams of ice per 100 grams of product versus degrees Fahrenheit at temperatures below the freezing temperature of pure water at standard conditions (32° F.). Table 3 is a table comparing the compositions, freezing points, and grams of ice per 100 grams of product at various temperature of the white mixes of Examples 1 and 2.

TABLE 3
Comparison of Frozen Dessert Compositions Explained in
Example 1 and Example 2

| | Example 1 | Example 2 |
|---|---|---|
| Component | White Mix | White Mix |
| Milk Solids Non-Fat (wt %) | 4.31 | 10.13 |
| Sucrose Eqivalent (wt %) | 39.40 | 39.36 |
| Fat (wt %) | 23.15 | 13.85 |
| Total Solids (wt %) | 45.93 | 39.50 |
| Freezing point (° F.) | 22.98 | 23.64 |
| g Ice/100 g Product at 22° F. | 4.77 | 9.03 |
| g Ice/100 g Product at 10° F. | 28.91 | 34.44 |

As shown in Table 3 above, the freezing point of the white mix of Example 2 (206) is more than 0.65° F. higher than the white mix of Example 1 (105). Thus, all else equal, when the sources of ethyl alcohol are added to the white mix at the flavor tank, the freezing point of the resulting flavored mix of Example 2 (210) will be higher than the freezing point of the resulting flavored mix of Example 1 (109). Therefore, the use of the substitution system 203 in Example 2 compensates for at least a part of the FPD effects of adding the sources of ethyl alcohol.

By way of example, as shown in Table 3 and as depicted in FIG. 3, at a temperature of 22° F. (vertical line 301), more grams of ice per 100 grams of product is present in the white mix of Example 2 (horizontal line 301b) than in the white mix of Example 1 (horizontal line 301a). Similarly, at a temperature of 10° F. (vertical line 302) more grams of ice per 100 grams of product is present in the white mix of Example 2 (horizontal line 302b) than in the white mix of Example 1 (horizontal line 302a).

The freezing profile of the white mix of Example 2 performs better than the freezing profile of the white mix of Example 1 in that, because more of the white mix of Example 2 is frozen at a given freezing temperature, the white mix of Example 2 can better compensate for the FPD effects of the ethyl alcohol on the flavored mix. Specifically, if, all else equal, the same amount and type of the sources of ethyl alcohol were added to the white mixes of Examples 1 and 2, the FPD effects of the sources ethyl alcohol will cause the freezing points of the resulting flavored mixes of Examples 1 and 2 to decrease, but the freezing point of the flavored mix of Example 2 will remain higher than the freezing point of the flavored mix of Example 1 because the substitution system in Example 2 (203) that compensates for the FPD effects of the sources of ethyl alcohol. Compensating for the FPD effects of the sources of ethyl alcohol using the substitution system can increase the grams of ice frozen per 100 grams of product, and thus improve the quality of the finished frozen dessert product.

### Example 3

Like Example 2, Example 3 replaces some of the sucrose of Example 1 with a substitution system. Example 3 also shows the use of a slurry. Other than these differences, the components in Example 3 are the same as the components in Example 2. This includes whole milk, heavy whipping cream, corn syrup (42DE), skim milk powder (no Vitamin A added), and stabilizer. The substitution system of Example 3 comprises HIS (e.g., stevia extract) and a bulking agent (e.g., maltodextrin). The quantity of HIS is calculated to have the same SSE as the amount of sugar that is replaced and the quantity of bulking agent may be calculated based on the amount of sugar that is replaced.

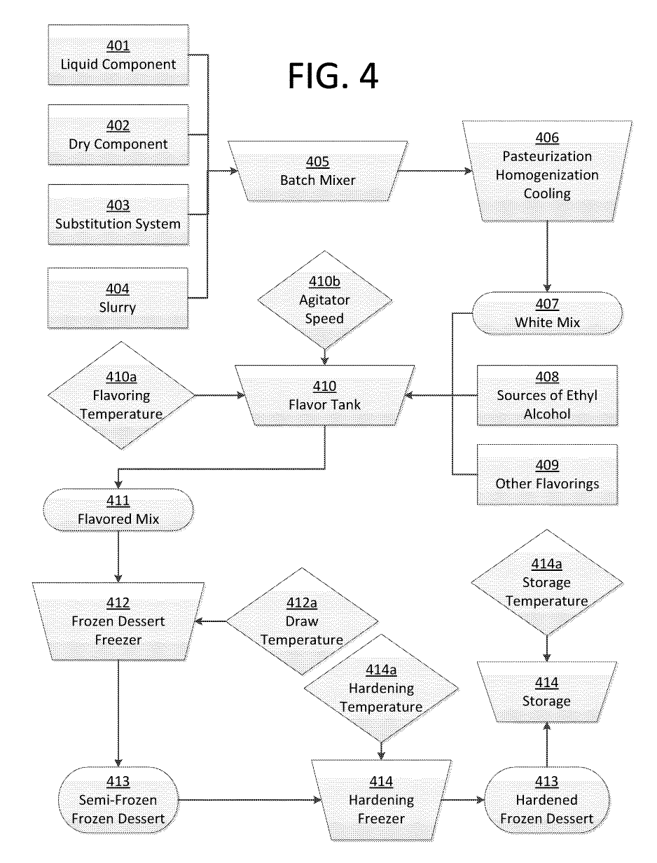

FIG. 4 is a flow chart of an example method of making an alcohol-containing frozen dessert using a substitution system and a slurry at 404. The slurry at 404 can comprise, for example, milk and corn starch. If the liquid component at 401 comprise milk, such milk may be reduced to compensate for the milk with the slurry at 404. The use of the slurry at 404 can enhance the dissolution of corn starch. The use of the slurry at 404 enhances the texture of the resulting frozen dessert to be reminiscent of a custard style frozen dessert.

The processes, settings, etc. described with respect to Example 2 and FIG. 2 are also applicable to Example 3 and FIG. 4. As with FIG. 2, the processes described herein are not limited to the order described in the example methods, and the combinations discussed with respect to 401, 402, 403, 404, 407, 408, 409 may be reordered, combined, reversed, etc.

### Example 4

Like Examples 2 and 3, Example 4 replaces some of the sugar of Example 1 with a substitution system. In Example 4, the sugar that is at least partially replaced is not sucrose or a traditional sweetener, but is the lactose from the milk, cream, milk powder, concentrated dairy products, etc. Milk, cream, milk powder, concentrated dairy products, and other components that may contain lactose may be at least partially replaced by reduced lactose, lactose-free, and/or non-dairy (e.g., nut-based, soy-based, etc.) components, which are commercially available. Other than these differences, the components in Example 4 are generally the same as the components in Example 2. The substitution system of Example 4 comprises HIS and a bulking agent.

The quantity of HIS is calculated to have the same SSE as the amount of sugar that is replaced and the quantity of bulking agent may be calculated based on the amount of sugar that is replaced. As noted above, the SSE of lactose is 0.2 such that replacement of lactose will use less HIS than replacement of the same amount of sucrose. For example, replacement of 3.9 g of sucrose in Example 2 uses 0.013 g stevia having SSE of 300. Replacement of 3.9 g of lactose would use only 0.0026 g of the same stevia to maintain the SSE in the frozen dessert.

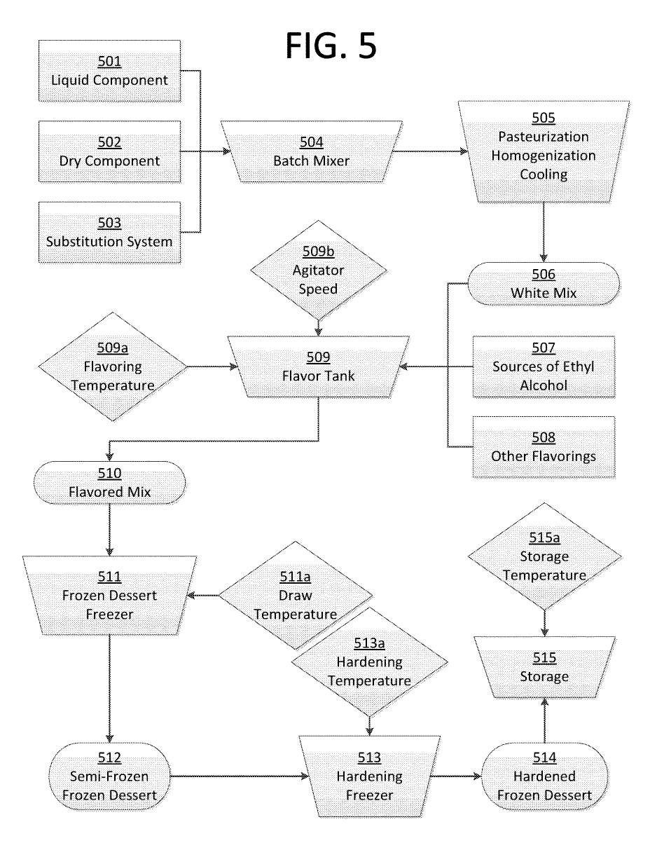

FIG. 5 is a flow chart of an example method of making an alcohol-containing frozen dessert using a substitution system and reduced lactose. The liquid component 501 can comprise, for example, reduced lactose, lactose-free, and/or non-dairy milk; reduced lactose, lactose-free, and/or non-dairy cream; sugar syrup; and corn syrup. The dry component at 502 can comprise, for example, reduced lactose, lactose-free, and/or non-dairy milk powder and sucrose. The remaining processes, settings, etc. described with respect to Example 2 and FIG. 2 are also applicable to Example 4 and FIG. 5. As with FIG. 2, the processes described herein are not limited to the order described in the example methods, and the combinations discussed with respect to 501, 502, 503, 506, 507, 508 may be reordered, combined, reversed, etc. A slurry may be used to enhance the texture of the resulting frozen dessert to be reminiscent of a custard style frozen dessert, for example as described with respect to FIG. 4.

In addition to increasing freezing point by replacing lactose that depresses freezing point with a smaller quantity of HIS that does not depress freezing point as much, removal of lactose can advantageously expand the market of the frozen dessert to the lactose-intolerant. In embodiments comprising non-dairy ingredients, removal of lactose can advantageously expand the market of the frozen dessert to vegans and others with dietary restrictions against dairy.

### Example 5

Like Examples 2, 3, and 4, Example 5 replaces some of the sugar of Example 1 with a substitution system. In Example 5, the sugar that is at least partially replaced is both sucrose or a traditional sweetener and the lactose from the milk, cream, milk powder, etc. Milk, cream, milk powder, and other components that may contain lactose may be at least partially replaced by reduced lactose, lactose-free, and/or non-dairy (e.g., nut-based, soy-based, etc.) components, which are commercially available. Other than these differences, the components in Example 5 are generally the same as the components in Examples 2 and 4. The substitution system of Example 5 comprises HIS and a bulking agent. In some embodiments, the same HIS may be used to replace at least some of the lactose and at least some of the sucrose. In some embodiments, a first HIS is used to replace at least some of the lactose and a second HIS different than the first HIS is used to replace at least some of the sucrose. The use of a plurality of HISS in Example 5 can be non-specific to the particular traditional sweetener being replaced as long as the SSE is substantially the same.

The quantity of HIS is calculated to have the same SSE as the amount of sugar that is replaced and the quantity of bulking agent may be calculated based on the amount of sugar that is replaced. As noted above, the SSE of lactose is 0.2 such that replacement of lactose will use less HIS than replacement of the same amount of sucrose. For example, replacement of 3.9 g of sucrose would use 0.013 g stevia having SSE of 300 and replacement of 3.9 g of lactose would use 0.0026 g of the same stevia for a total of 0.0156 g stevia.

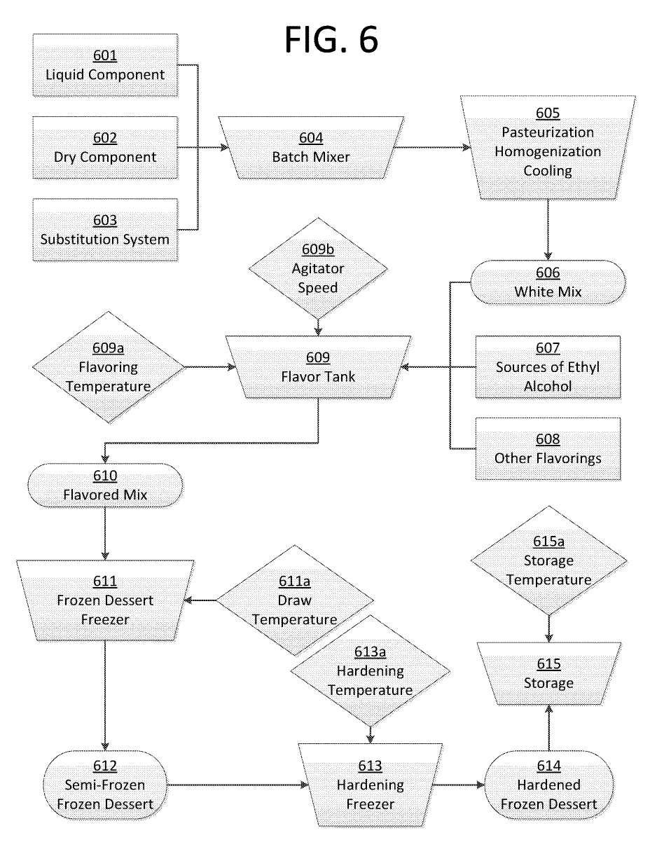

FIG. 6 is a flow chart of an example method of making an alcohol-containing frozen dessert using a substitution system and reduced lactose and sucrose. The processes, settings, advantages, etc. described with respect to Examples 2 and 4 and FIGS. 2 and 5 are also applicable to Example 5 and FIG. 6. As with FIG. 2, the processes described herein are not limited to the order described in the example methods, and the combinations discussed with respect to 601, 602, 603, 606, 607, 608 may be reordered, combined, reversed, etc. A slurry may be used to enhance the texture of the resulting frozen dessert to be reminiscent of a custard style frozen dessert, for example as described with respect to FIG. 4.

Although certain compositions and methods are described herein in connection with frozen dessert compositions and methods of manufacturing the same, the compositions and methods described herein can be used to make frozen dessert compositions having any manufacturing sequence (e.g., liquid ingredients before dry ingredients and vice versa) and comprising any component of a frozen dessert composition (e.g., brazzein, polydextrose, etc.). For example, in some embodiments, the frozen dessert composition can comprise substitution system comprising sucrose. In some embodiments, the frozen dessert composition can comprise a substitution system comprising lactose.

Although certain embodiments and examples are described herein, it will be understood by those skilled in the art that many aspects of the frozen dessert compositions and methods of manufacturing the same shown and described in the present disclosure may be differently combined and/or modified to form still further embodiments or acceptable examples. All such modifications and variations are intended to be included herein within the scope of this disclosure. A wide variety of designs and approaches are possible. No feature, structure, or step disclosed herein is essential or indispensable.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent components, modifications, omissions, combinations (e.g., of various components), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed compositions and methods may be modified in any manner, including by reordering steps on the method and/or adding additional components and/or steps and/or removing components and/or steps. It is intended, therefore, that the specification and examples be considered as illustrative only, with a true scope and spirit being indicated by the claims and their full scope of equivalents.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain compositions and/or steps. Thus, such conditional language is not generally intended to imply that compositions and/or steps are in any way required for one or more embodiments.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±1%, ±5%, ±10%, ±15%, etc.). For example, “about 23° F.” includes “23° F.”

What is claimed is:

1. A frozen dessert composition comprising:
ethyl alcohol; and
a substitution system, the substitution system comprising:
a high intensity sweetener, and
a bulking agent.

2. The composition of claim 1, wherein the high intensity sweetener is between 0.05 wt % and 1 wt %.

3. The composition of claim 1, wherein the bulking agent is between 5 wt % and 15 wt %.

4. The composition of claim 1, wherein the ethyl alcohol is between 3 wt % and 15 wt %.

5. The composition of claim 1, wherein the high intensity sweetener is selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof.

6. The composition of claim 1, wherein the bulking agent is selected from the group consisting of carbohydrates, corn syrup solids, proteins, and combinations thereof.

7. The composition of claim 1, further comprising milk, cream, corn syrup, and milk powder.

8. The composition of claim 1, further comprising a stabilizer.

9. The composition of claim 1, further comprising other flavorings.

10. The composition of claim 1, further comprising a traditional sweetener, wherein the traditional sweetener and the high intensity sweetener provide a sucrose sweetness equivalence.

11. The composition of claim 10, wherein the traditional sweetener is between 2.5 wt % to 12.5 wt %.

12. The composition of claim 1, wherein a freezing point of the composition is between 22.5° F. and 23.5° F.

13. A method of making a frozen dessert comprising:
mixing a liquid component, a dry component, a substitution system, and ethyl alcohol to form a frozen dessert composition,
wherein the substitution system comprises:
a high intensity sweetener, and
a bulking agent; and
freezing the frozen dessert composition into a frozen dessert.

14. The method of claim 13, wherein the liquid component comprises milk, cream, and corn syrup and wherein the dry component comprises milk powder and a traditional sweetener.

15. The method of claim 13, further comprising freezing the frozen dessert to a hardening temperature.

16. The method of claim 15, wherein the hardening temperature is between −20° F. and −50° F.

17. The composition of claim 13, wherein a freezing point of the composition is between 22.5° F. and 23.5° F.

18. A substitution system comprising:
a high intensity sweetener, and
a bulking agent.

19. The system of claim 18, wherein the high intensity sweetener is selected from the group consisting of aspartame, acesulfame-K, alitame, brazzein, cyclamate, dihydrochalcones (DHCs), monk fruit extract, Neo DHC, neotame, sucralose, stevia, stevia derivatives, saccharine, thaumatin, and combinations thereof.

20. The system of claim 18, wherein the bulking agent is selected from the group consisting of carbohydrates, corn syrup solids, proteins, and combinations thereof.
